(19) United States
(12) Patent Application Publication
(10) Pub. No.: US 2026/0209573 A1
(43) Pub. Date: Jul. 23, 2026

(54) ADHESIVE TAPE FOR ADHESION TO A SURFACE HAVING A SELF-CLEANING PAINT APPLIED THEREON

(71) Applicant: Shurtape Technologies, LLC, Hickory, NC (US)

(72) Inventors: Matthew BAKER, Hickory, NC (US); Thomas ROGERS, Hickory, NC (US)

(21) Appl. No.: 19/033,169

(22) Filed: Jan. 21, 2025

(51) Int. Cl. C09J 11/08; C09J 5/00; C09J 7/38; C09J 11/06

(52) U.S. Cl. CPC C09J 11/08; C09J 5/00; C09J 7/383; C09J 11/06; C09J 2203/31; C09J 2203/366; C09J 2301/302; C09J 2301/408

(57) ABSTRACT

An adhesive tape having a substrate, and an adhesive layer on or adjacent to at least one side of the substrate, the adhesive layer having an adhesive comprising an acid modified tackifier. The adhesive tape is capable of being applied to a self-cleaning paint comprising silicone.

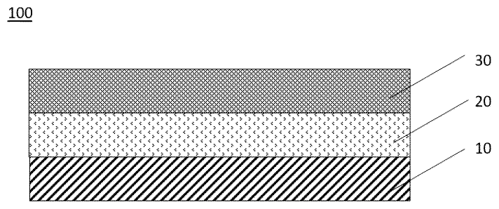

### FIELD OF THE INVENTION

The present invention relates to adhesive tape, more particularly to adhesive tape suitable for use on a surface, such as an exterior surface, having self-cleaning paint applied thereon.

### BACKGROUND OF THE INVENTION

Paint masking tapes are generally used for masking surfaces during the painting process and come in a variety of colors and adhesive types. These tapes are designed to bond with acceptable adhesion levels so that can stick instantly with sufficient force and remove after an extended period without damaging surfaces. Typical target surfaces include painted surfaces as well as a variety of unpainted surfaces. Paint manufacturers are introducing paints for exterior use that are durable and resist harsh environments. A new family of paints are offering a “self-cleaning” feature that resists dirt from adhering to these paints. There are self-cleaning paints on the market that contain silicone which repels dirt. Silicone is a low surface energy material that prevents wetting, a key step in adhesive bonding. As a result, most commercial masking tapes do not have a sufficient bond on self-cleaning paints to perform in the paint masking process.

Thus, there is a need in industry for a cost-effective adhesive tape with improved adhesion to surfaces painted with self-cleaning paint. For example, there is a need for a masking tape that does not have a tendency to fall off exterior surfaces having been painted with self-cleaning paints such as on the exterior of houses painted with self-cleaning paints. The adhesive tape and adhesive composition of the present invention overcome these shortcomings in order to solve an existing problem and to meet an industry need.

### SUMMARY OF THE INVENTION

The present invention is directed to an adhesive tape and an adhesive composition for use on a surface having a self-cleaning paint applied thereon.

Suitable self-cleaning tapes include, but are not limited to, self-cleaning tapes containing amine functionalized silicone.

The adhesive tape of the present invention comprises a higher acid content adhesive than adhesives of traditional adhesive tapes for use with self-cleaning paints yet the adhesive tape of the present invention achieves the desired results with a lower thickness of adhesive.

In an embodiment of the invention, an adhesive tape comprises: a substrate, and an adhesive layer on or adjacent to at least one side of the substrate, the adhesive layer having an adhesive comprising an acid modified tackifier. The adhesive tape is capable of being applied to a self-cleaning paint comprising silicone. In an aspect of the invention, the silicone is amine functionalized. In an aspect of the invention, the adhesive is a pressure sensitive adhesive. The acid modified tackifier can be selected from the group consisting of a rosin acid tackifier, a rosin ester tackifier, and a combination thereof.

In an embodiment of the invention, the adhesive tape has an acid modified tackifier comprising: a tackifying resin, and a rosin acid or a modified rosin acid. The tackifying resin is selected from the group consisting of C5 to C9 hydrocarbon resins, terpene resins, polyterpenes, terpene monomers, terpene monomers copolymerized with an aromatic monomer, pure monomer resins, and a combination thereof. The rosin acid can be abietec acid. The substrate can be paper, plastic, cloth, a nonwoven, or a combination thereof. The adhesive tape can be a masking tape, a painters tape, a duct tape, a cloth tape, or a mounting tape. The adhesive may further comprise a natural rubber, a phenolic resin, inorganic filler, an accelerator, antioxidant, naphthenic oil, or a combination thereof.

In an embodiment of the invention, the adhesive tape comprises: a substrate, and an adhesive layer on or adjacent to at least one side of the substrate, the adhesive layer having an adhesive composition comprising: a tackifying resin in a range of 38 weight percent to 44 weight percent; a natural rubber in a range of 30 weight percent to 37 weight percent; a phenolic resin in a range of 5 weight percent to 8 weight percent; an inorganic filler in a range of 10 weight percent to 14 weight percent; a toluene sulfonic acid in a range of 2 weight percent to 4 weight percent; an antioxidant in a range of 0.2 weight percent to 0.4 weight percent; a naphthenic oil in a range of 0.2 weight percent to 0.4 weight percent; a rosin acid or a modified rosin acid in a range of 0.1 weight percent to 8 weight percent; wherein the weight percentages are based on the weight of the adhesive composition.

In an embodiment of the invention, the adhesive composition comprises: a tackifying resin in a range of 38 weight percent to 44 weight percent; a natural rubber in a range of 30 weight percent to 37 weight percent; a phenolic resin in a range of 5 weight percent to 8 weight percent; an inorganic filler in a range of 10 weight percent to 14 weight percent; a toluene sulfonic acid in a range of 2 weight percent to 4 weight percent; an antioxidant in a range of 0.2 weight percent to 0.4 weight percent; a naphthenic oil in a range of 0.2 weight percent to 0.4 weight percent; a rosin acid or a modified rosin acid in a range of 0.1 weight percent to 8 weight percent, wherein the weight percentages are based on the weight of the adhesive composition.

In an embodiment of the invention, a method of using is provided. The method of using comprises obtaining an adhesive tape having an adhesive composition comprising: a tackifying resin; and a rosin acid or a modified rosin acid; and applying the adhesive tape to a surface having a self-cleaning paint applied thereon. In an aspect of the invention, the self-cleaning paint comprises silicone. The silicone can be amine functionalized. The adhesive can be a pressure sensitive adhesive. In an aspect of the invention, the acid modified tackifier is selected from the group consisting of a rosin acid tackifier, a rosin ester tackifier, and a combination thereof. The acid modified tackifier comprises: a tackifying resin, and a rosin acid or a modified rosin acid. The tackifying resin is selected from the group consisting of C5 to C9 hydrocarbon resins, terpene resins, polyterpenes, terpene monomers, terpene monomers copolymerized with an aromatic monomer, pure monomer resins, and a combination thereof. The rosin acid is abietec acid. The substrate is paper, plastic, cloth, a nonwoven, or a combination thereof. The adhesive tape is a masking tape, a painters tape, a duct tape, a cloth tape, or a mounting tape. In another aspect, the adhesive further comprises a natural rubber, a phenolic resin, inorganic filler, an accelerator, antioxidant, naphthenic oil, or a combination thereof.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

The FIGURE is a schematic cross-sectional view of an adhesive tape in accordance with aspects according to the invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

### Adhesive Tape

In an aspect of the invention, an adhesive tape for use on a surface having a self-cleaning paint applied thereon is provided. The adhesive tape comprises a substrate and an adhesive layer present on at least one side of the substrate.

The substrate is preferably made of paper. The substrate can be made of other materials including, but not limited to, plastic such as polyethylene and polypropylene film, cloth, non-woven, and a combination(s) thereof.

When the adhesive tape is a masking tape, the adhesive layer preferably has a pressure-sensitive adhesive composition applied thereon.

The adhesive tape may further comprise an optional liner.

Referring to the FIGURE, a schematic cross-sectional view of an adhesive tape 100 in accordance with aspects of the invention is illustrated. Adhesive tape 100 comprises a substrate 10 and an adhesive layer 20 applied to at least one side of substrate 10. An optional liner layer 30 may be adjacent to adhesive layer 20.

### Adhesive Composition

In an aspect of the invention, an adhesive is provided. Preferably, a solvent-based adhesive. The adhesive is a pressure sensitive adhesive.

In an aspect of the invention, the adhesive of the adhesive layer comprises an acid-modified tackifier. The acid-modified tackifier may comprise: a tackifying resin; and a rosin acid or a modified rosin acid.

Examples of acid-modified tackifiers include, but are not limited to, rosin acid tackifier, a rosin ester tackifier, or a combination(s) thereof.

Rosin acid tackifiers are commercially available. An example of a highly hydrogenated crystal-clear rosin acid tackifier is Foral AX from Pinova.

Rosin ester tackifiers are commercially available in varying softening points from 25° C. to 105° C. and varying degrees of hydrogenation. Examples of commercially available low softening point liquid resins include, but are not limited to, Sylvatac RE25 from Arizona Chemical Company. Examples of 85° C. S.P. glycerol rosin esters include, but are not limited to, the highly hydrogenated Foral 85 from Pinova or a tall oil based Sylvatac RE85 from Arizona Chemical. Examples of 105° C. S.P. Pentaerythritol rosin esters include, but are not limited to, Sylvalite RE105 from Arizona or Foral 105 from Pinova.

Other tackifying resins can be obtained for use in the adhesive of the present invention. Examples include, but are not limited to, hydrocarbon resins having low molecular weight (MW) oligomers of C5, dicyclopentadiene, C9 feed streams or combinations of such feed streams. Generally speaking, C5 tackifying resins are oligomers comprised of aliphatic or cycloaliphatic monomers with carbon lengths of 5 to 6. Aromatic monomers with carbon lengths of 9 are used to produce aromatic C9 tackifiers. Many times, C5 feed streams are blended with C9 feed streams before polymerization to produce a mixed C5/C9 tackifier. Furthermore, after oligomer production the resin can be hydrogenated to change its solubility and aging properties.

Another example of a tackifying resin is an aliphatic C5 resin. Commercially available aliphatic C5 resins include, but are not limited to, Wingtack 95 from Cray Valley, the Escorez 1000 series from Exxon and the Piccotac 1000 series from Eastman Chemical. Cycloaliphatic DCPD resins include, but are not limited to, Escorez 5000 series from Exxon. The C5 to C9 hydrocarbon resins are derived from aliphatic and aromatic mixed feed streams, they include, but are not limited to, the Wingtack Extra, Wingtack 86, the Escorez 2000 series from Exxon or the Piccotac 9000 series. C9 or aromatic resins are available from various manufacturers including, but not limited to, the Picco line from Eastman, the Hikotack line from Kolon and from Hexion.

Terpene resins or polyterpenes are oligomers that may be used as tackifying resins. They are produced from several naturally occurring monomers including alpha and beta pinene, which are extracted from pine trees, and d-limonene, extracted from citrus fruit peels. Examples include, but are not limited to, Sylvares TR B115 from Arizona or the Piccolyte series from Pinova.

Terpene monomers can also be copolymerized with aromatic monomers including styrene, phenol or others to give unique polymer solubility and adhesive properties. A non-limiting example of a 96° C. S.P. terpene phenol is Sylvares TP96 from Arizona. A non-limiting example of a styrenated terpene is Sylvares 6100 from Arizona.

Pure monomer resins are also available, they are specialty tackifiers and are incorporated when very specific compatibility or final properties are desired. Eastman Chemical's Kristalex, Regalrez and Endex series are available, an example of commonly used hydrogenated pure monomer resin is Regalrez 1085.

Other examples of commercially available tackifying resins include, but are not limited to, Quintone K100, Escorez 1310LC, Escorez 1304, Wingtac 98, Teckrez C5-95, Teckrez C5-100, Piccotac 1098, Piccotac 1095, Teckrez C5-98, among others.

In an aspect of the invention, the adhesive composition may further comprise a natural rubber, a phenolic resin, inorganic filler, an accelerator, antioxidant, naphthenic oil, a rosin acid or a modified rosin acid, or a combination thereof.

Examples of commercially available natural rubbers include, but are not limited to, Ribbed Smoked Sheet, SIR-3, STRL-5L, SMR-3, SMR-5, SMR-20, CV-60, Skim Block, SIR-20, SVR 3 Rubber, SIR 10 Rubber, among others.

A non-limiting example of a phenolic resin is phenol formaldehyde resin. Examples of commercially available phenolic resins include, but are not limited to, SI Group HRJ 10518, phenolic resins produced by Rain Carbon Inc. and sold under the Novares line, DIC chemical's Phenolite PE series, Schenectady Chemical's phenolic resins, or SBHPP's Resol line.

Non-limiting examples of inorganic fillers are calcium carbonate, zinc oxide, and TiO₂. Examples of commercially available inorganic fillers include, but are not limited to, VICRON 31-6, Imerys 10 CaCO₂, French ZnO, TI Pure R706, rutile TiO₂, anatase TiO₂, among others.

A non-limiting example of an accelerator is toluene sulfonic acid.

A non-limiting example of an antioxidant is polyphenol. Examples of commercially available antioxidants are BNX 8000 and Wingstay L.

A non-limiting example of a rosin acid is abietec acid. Abietic acid is originally derived from pine trees. It is obtained commercially as gum rosin from by harvesting from the live tree. It can also be extracted from pine tree stumps, referred to as wood rosin. Rosin is commonly secured through the post processing of tall oil, a waste product of paper making. Rosin can be used in its natural form as rosin acid but many times it is processed further to improve aging characteristics or provide a specific need to the final adhesive. Rosin is many times esterified with various alcohols to produce rosin esters and the esters are further processed using hydrogenation or disproportionation. Also, other useful rosin products are prepared using processes that dimerize, polymerize, salt the abietic acid after this step is complete further hydrogenation or disproportionation steps can be used.

Examples of modified rosin acids having an acid number include, but are not limited to: rosin disproportionated and/or hydrogenated (partial or full); dimerized; dimerized and esterified; and modified with maleic anhydride or fumaric acid (higher acid numbers).

Examples of modified rosin acids not having an acid number include, but are not limited to, esterified fully or partially; rosin soap; and zinc rosinate/resinate.

Examples of commercially available rosin acids and/or modified rosin acids include, but are not limited to, Resin H, Synthomer Staybelite E, TECKROS® NC100.

In an aspect of the invention, an adhesive composition of the invention may comprise the following weight percentages of components. The tackifying resin may be present in a range of 38 weight percent to 44 weight percent, wherein the weight percentage is based on the weight of the total adhesive composition. The natural rubber may be present in a range of 30 weight percent to 37 weight percent, wherein the weight percentage is based on the weight of the total adhesive composition. The phenolic resin may be present in a range of 5 weight percent to 8 weight percent, wherein the weight percentage is based on the weight of the total adhesive composition. The inorganic filler may be present in a range of 10 weight percent to 14 weight percent, wherein the weight percentage is based on the weight of the total adhesive composition. The toluene sulfonic acid may be present in a range of 2 weight percent to 4 weight percent, wherein the weight percentage is based on the weight of the total adhesive composition. The antioxidant may be present in a range of 0.2 weight percent to 0.4 weight percent, wherein the weight percentage is based on the weight of the total adhesive composition. The naphthenic oil may be present in a range of 0.2 weight percent to 0.4 weight percent, wherein the weight percentage is based on the weight of the total adhesive composition. The rosin acid or modified rosin acid may be present in a range of 0.1 weight percent to 8 weight percent, wherein the weight percentage is based on the weight of the total adhesive composition.

The adhesive composition of the invention has been demonstrated to show improved adhesion on self-cleaning painted surface at lower adhesive thicknesses. In an aspect of the invention the adhesive composition has a thickness in a range of 0.5 mils to 3 mils and has a peel adhesion in a range of in a range of 15 oz/in to 35 oz/in on a surface having a self-cleaning paint applied thereon. Furthermore, the use of an acid-modified tackifying resin in the pressure sensitive adhesive to adhere to a self-cleaning painted surface containing silicone, including amine functionalized silicone, is believed to be unique and unexpected.

Although the adhesive of the invention is a solvent based adhesive, it is within the scope of the invention that other adhesive types (for example, synthetic rubber, acrylic) and a range of acid modified tackifiers could be used.

Preferably, the adhesive composition of the invention is used as a masking tape or painter's tape. The adhesive composition can potentially be used for other types of tapes including, but not limited to, a duct tape, cloth tape, or mounting tape. The adhesive composition can potentially be used for long-term, more permanent bonds.

In another aspect of the invention, a method of using the adhesive composition is provided. The method of using comprises: obtaining an adhesive tape having an adhesive composition comprising: a tackifying resin; and a rosin acid or a modified rosin acid; and applying the adhesive tape to a surface having a self-cleaning paint applied thereon.

### Examples

Comparative Example: Peel adhesion data of various commercial products was obtained and is provided to illustrate the poor adhesion to a surface painted with a self-cleaning paint.

TABLE 1

| | Adhesion to Painted Wood Trim | | | | |
|---|---|---|---|---|---|
| | (Loxon Self-Cleaning Satin Paint) | | | | |
| | 4 hours | 1 day | 3 days | 7 days | |
| Dwell Time | oz/in | oz/in | oz/in | oz/in | FOM* |
| CP199 Original | 10 | 10 | 10 | 11 | 41 |
| PMG Ultra | 5 | 6 | 6 | 6 | 22 |
| Frog Delicate (CF160) | 5 | 3 | 5 | 4 | 18 |
| CX 168 (CP 66) | 3 | 5 | 3 | 5 | 17 |
| 3M 2090 | 5 | 4 | 4 | 3 | 16 |
| 3M 2093 | 4 | 3 | 4 | 4 | 15 |
| Frog Multi (CF120) | 4 | 3 | 4 | 2 | 13 |
| Frog Pro (CP27) | 3 | 4 | 3 | 2 | 11 |
| PMG | 1 | 1 | 1 | 1 | 3 |
| ProMask PT14 | 0 | 1 | 0 | 1 | 2 |

*FOM (Figure of Merit) - sum of adhesion values over different dwell times.
** CP199 Original - FrogTape Pro Grade Orange Painter's Tape

Note that none of the above reached the target peel adhesion range of 15 oz/in to 35 oz/in. Thus, there were no adhesions in the desired range.

Example—This data shows favorable adhesion results for the adhesive tape of the invention on a self-cleaning painted surface but with a reduced thickness of adhesive required.

TABLE 1

| | Adhesion to Painted Wood Trim | | | | |
|---|---|---|---|---|---|
| | (Loxon Self-Cleaning Satin Paint) | | | | |
| | 4 hours | 1 day | 3 days | 7 days | |
| Dwell Time | oz/in | oz/in | oz/in | oz/in | FOM* |
| Test sample with | 31 | 36 | 33 | 27 | 128 |
| rosin acid (5 weight | | | | | |
| %) @1.44 oz/sy | | | | | |
| Test sample with | 23 | 19 | 24 | 21 | 86 |
| rosin acid (1 weight | | | | | |
| %) @1.44 oz/sy | | | | | |
| CP199 @ (1.7 oz/sy) | 19 | 19 | 23 | 22 | 83 |
| CP199 @ (1.44 oz/sy) | 18 | 17 | 18 | 17 | 70 |
| CP199 Original @ | 10 | 10 | 9 | 9 | 38 |
| (1.2 oz/sy) | | | | | |

*FOM (Figure of Merit) - sum of adhesion values over different dwell times.
** CP199 Original - FrogTape Pro Grade Orange Painter's Tape

The quality of how well a tape is bonded to a surface is typically measured by peel adhesion and is described in the PSTC test method 101. Peel adhesion measures the force required to debond a tape from a surface. The force and the separation mode (e.g., clean from the surface, adhesive split) is noted during this test. The peel results are dictated by the interaction of the adhesive to the surface, cohesive strength of the adhesive, and the rheology of the adhesive. For masking tapes, the cohesive strength of the tape is very high, so the interaction at the surface and the rheology dictates the separation force.

Testing of commercially available tapes showed that none had acceptable adhesion to two self-cleaning paints commercially available from Sherwin Williams.

CP199 Original is comprised of a paper backing and a pressure sensitive adhesive. The pressure sensitive adhesive components were dissolved in a solvent, applied to the paper backing, and dried. In regard to modifications to CP199 Original, increased adhesive thickness affected the rheology that marginally improved the peel adhesion.

A modification to the CP199 adhesive was explored to achieve good adhesion at lower adhesive thickness. A high acid tackifier that is compatible with the rubber system, Staybelite with acid number greater of 160, was sourced from Synthomer (previously Eastman Chemical). Results showed a significant increase in adhesion with 1 weight % and 5 weight % addition of Staybelite to the CP199 adhesive.

It was surprisingly found that addition of an acid modified tackifying resin showed a significant increase in adhesion and that addition of rosin acid allowed for lower coat weights.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended to be construed to limit the present invention or otherwise to exclude any such other embodiments, adaptations, variations, modifications and equivalent arrangements.

What is claimed is:

1. An adhesive tape comprising:
a substrate, and
an adhesive layer on or adjacent to at least one side of the substrate, the adhesive layer having an adhesive comprising an acid modified tackifier.

2. The adhesive tape according to claim 1, wherein the adhesive tape is capable of being applied to a self-cleaning paint comprising silicone.

3. The adhesive tape according to claim 2, wherein the silicone is amine functionalized.

4. The adhesive tape according to claim 1, wherein the adhesive is a pressure sensitive adhesive.

5. The adhesive tape according to claim 1, wherein the acid modified tackifier is selected from the group consisting of a rosin acid tackifier, a rosin ester tackifier, and a combination thereof.

6. The adhesive tape according to claim 1, wherein the acid modified tackifier comprises:
a tackifying resin, and
a rosin acid or a modified rosin acid.

7. The adhesive tape according to claim 6, wherein the tackifying resin is selected from the group consisting of C5 to C9 hydrocarbon resins, terpene resins, polyterpenes, terpene monomers, terpene monomers copolymerized with an aromatic monomer, pure monomer resins, and a combination thereof.

8. The adhesive tape according to claim 5, wherein the rosin acid is abietec acid.

9. The adhesive tape according to claim 1, wherein the substrate is paper, plastic, cloth, a nonwoven, or a combination thereof.

10. The adhesive tape according to claim 1, wherein the adhesive tape is a masking tape, a painters tape, a duct tape, a cloth tape, or a mounting tape.

11. The adhesive tape according to claim 1, wherein the adhesive further comprises a natural rubber, a phenolic resin, inorganic filler, an accelerator, antioxidant, naphthenic oil, or a combination thereof.

12. An adhesive tape comprising:
a substrate, and
an adhesive layer on or adjacent to at least one side of the substrate, the adhesive layer having an adhesive composition comprising:
a tackifying resin in a range of 38 weight percent to 44 weight percent,
a natural rubber in a range of 30 weight percent to 37 weight percent,
a phenolic resin in a range of 5 weight percent to 8 weight percent,
an inorganic filler in a range of 10 weight percent to 14 weight percent,
a toluene sulfonic acid in a range of 2 weight percent to 4 weight percent,
an antioxidant in a range of 0.2 weight percent to 0.4 weight percent,
a naphthenic oil in a range of 0.2 weight percent to 0.4 weight percent,
a rosin acid or a modified rosin acid in a range of 0.1 weight percent to 8 weight percent,
wherein the weight percentages are based on the weight of the adhesive composition.

13. An adhesive composition comprising:
a tackifying resin in a range of 38 weight percent to 44 weight percent,
a natural rubber in a range of 30 weight percent to 37 weight percent,
a phenolic resin in a range of 5 weight percent to 8 weight percent,
an inorganic filler in a range of 10 weight percent to 14 weight percent,
a toluene sulfonic acid in a range of 2 weight percent to 4 weight percent,
an antioxidant in a range of 0.2 weight percent to 0.4 weight percent,
a naphthenic oil in a range of 0.2 weight percent to 0.4 weight percent,
a rosin acid or a modified rosin acid in a range of 0.1 weight percent to 8 weight percent,
wherein the weight percentages are based on the weight of the adhesive composition.

14. A method of using comprising:
obtaining an adhesive tape having an adhesive composition comprising: a tackifying resin; and a rosin acid or a modified rosin acid; and
applying the adhesive tape to a surface having a self-cleaning paint applied thereon.

15. The method of using according to claim 14, wherein the self-cleaning paint comprises silicone.

16. The method of using according to claim 15, wherein the silicone is amine functionalized.

17. The method of using according to claim 14, wherein the adhesive is a pressure sensitive adhesive.

18. The method of using according to claim 14, wherein the acid modified tackifier is selected from the group consisting of a rosin acid tackifier, a rosin ester tackifier, and a combination thereof.

19. The method of using according to claim 14, wherein the acid modified tackifier comprises:
a tackifying resin, and
a rosin acid or a modified rosin acid.

20. The method of using according to claim 19, wherein the tackifying resin is selected from the group consisting of C5 to C9 hydrocarbon resins, terpene resins, polyterpenes, terpene monomers, terpene monomers copolymerized with an aromatic monomer, pure monomer resins, and a combination thereof.

21. The method of using according to claim 19, wherein the rosin acid is abietec acid.

22. The method of using according to claim 14, wherein the adhesive tape further comprises a substrate and the substrate is paper, plastic, cloth, a nonwoven, or a combination thereof.

23. The method of using according to claim 14, wherein the adhesive tape is a masking tape, a painters tape, a duct tape, a cloth tape, or a mounting tape.

24. The method of using according to claim 14, wherein the adhesive composition further comprises a natural rubber, a phenolic resin, inorganic filler, an accelerator, antioxidant, naphthenic oil, or a combination thereof.
